(19) United States
(12) Patent Application Publication
(10) Pub. No.: US 2006/0074786 A1
(43) Pub. Date: Apr. 6, 2006

(54) System and method for collateralized debt obligations

(76) Inventors: Mark L. Zusy, Old Brookville, NY (US); Keith Y. Lee, Guttenberg, NJ (US)

Correspondence Address: MORGAN LEWIS & BOCKIUS LLP, 1111 PENNSYLVANIA AVENUE NW, WASHINGTON, DC, 20004, US

(21) Appl. No.: 10/986,429

(22) Filed: Nov. 10, 2004

Related U.S. Application Data
(60) Provisional application No. 60/552,251, filed on Mar. 11, 2004.

(51) Int. Cl. G06Q 40/00

(52) U.S. Cl. 705/35

(57) ABSTRACT

A collateralized debt obligation is described having a subordinated revolver note. The revolver noteholder is committed providing funds to purchase additional assets to maintain the original principal value of the collateral. The amount of additional assets is determined at the end of each due period on the determination date. Funds to purchase the additional assets are received from the revolver noteholder, if required, on the payment date. The payment date follows the determination date by a predetermined period, preferably by five business days. The delay between the determination date and the payment date reduces the liquidity requirement of the revolver noteholder thereby increasing the marketability of the revolver note.

### CROSS-REFERENCE TO RELATED APPLICATIONS

This application claims the benefit under 35 U.S.C. § 119 of prior filed provisional application Ser. No. 60/552,251, filed Mar. 11, 2004, which is incorporated herein by reference in its entirety.

### BACKGROUND OF THE INVENTION

1. Field of the Invention

The present invention relates to financial products. More specifically, the invention relates to collateralized debt obligation (CDO) financial products.

2. Description of the Related Art

A collateralized debt obligation (CDO) is a structured finance product that securitizes a diversified pool of debt assets into multiple classes of notes. A collateralized loan obligation (CLO) is similar to a CDO where the debt assets are loans or derivatives based on loans. Similarly, a collateralized bond obligation (CBO) is a CDO where the underlying asset is comprised of bonds or derivatives based on bonds. As used hereinafter, CDO refers to both CLO and CBO. The note structure of the CDO creates custom exposures to the underlying assets that are desirable to a wide spectrum of investors. Investors with a higher risk tolerance may prefer the subordinated or equity tranches of the CDO, which have the potential to provide higher returns. Other investors with a lower risk tolerance may prefer the senior tranches of the CDO.

A CDO is formed by Special Purpose Vehicle (SPV) that may be a trust, corporation, partnership, or limited liability company. The SPV is organized to purchase assets and issue debt and equity tranches in the form of a series of hierarchically structured notes. The highest class of notes is usually referred to as the senior tranche. The notes below the senior tranche are usually referred to as the subordinated notes. Below the most subordinated note class is the equity tranche, which are usually sold as preferred shares. The ranking of each tranche determines the order of payments made to each tranche. This order is usually referred to as a waterfall. The waterfall can significantly affect the cash flows of each of the tranches and must be balanced such that all debt and equity tranches are willing to purchase the notes.

Most CDOs are designed like closed-end funds where the assets are predominately purchased before or during the ramp-up phase and only a limited amount of additional assets enter the fund throughout the life of the deal. At the beginning of the CDO, the principal balance of assets is equal to the principal amounts of the funded notes and equity less the upfront fees and expenses of the CDO. However, due the speculative nature of the underlying assets and their probability of default, it is unlikely that the principal balance of assets will be sufficient pay back a significant portion of the initial amount of equity. As a result, the equity tranche receives a relatively large leveraged cash flow early in the CDO to offset the relatively high risk that they will not receive anything at the end of the CDO. During the life of the CDO, some of the underlying assets may default, which lowers the value of the underlying assets. The decreasing value of the underlying assets, however, increases the risk to the senior tranche. The senior tranche is protected by sizing the equity tranche to cover the expected defaults. In a typical CDO, the equity tranche is between 8-12% of underlying assets.

The senior tranche is also protected by the credit support provided by the subordinated tranches. The credit support provided to each note class by the more junior note classes may be characterized by an OverCollateralization Ratio (OCR), which is the ratio of the par amount of the CDO's assets to the outstanding par amount of that note class and the note classes senior to it. The most senior note class will have the largest OCR and the most junior note class will have the smallest OCR.

As the CDO ages, the credit support structure of the CDO changes as the payments made to each note class according to the waterfall changes the relative proportion of each note class differently. Therefore, there remains a need for structured finance products that have a more desirable cash flow structure and reduced risk for each tranche.

### SUMMARY OF THE INVENTION

One embodiment of the present invention is directed to a financial product comprising: a collateral comprising at least one underlying asset, the collateral characterized by a principal value and a net principal loss for a due period terminated by a determination date when the net principal loss is calculated for the due period; a senior debt tranche; a revolver debt tranche subordinate to the senior debt tranche; at least one subordinate debt tranche subordinate to the revolver debt tranche; and an equity tranche subordinate to the at least one subordinate debt tranche and issued as a preferred share, wherein the revolver debt tranche is commited to providing funds equal to the net principal loss at a payment date that is a predetermined number of days following the determination date.

Another embodiment of the present invention is directed to a method of securitizing a collateral of assets, the collateral characterized by a principal value, the method comprising: calculating a net principal loss of the collateral during a due period on a determination date, the determination date terminating the due period; and purchasing at least one replenishment asset on a payment date to maintain the principal value of the collateral, the payment date following the determination date by a predetermined period.

### BRIEF DESCRIPTION OF THE DRAWINGS

The invention will be described by reference to the preferred and alternative embodiments thereof in conjunction with the drawings in which:

FIG. 1 is a diagram illustrating the transactions and structural features of one embodiment of the present invention;

FIG. 2 is a diagram illustrating the replenishment of the collateral in one embodiment of the present invention;

FIG. 3 is a diagram illustrating the interest waterfall in one embodiment of the present invention; and

FIG. 4 is a diagram illustrating the principal waterfall in one embodiment of the present invention.

### DETAILED DESCRIPTION

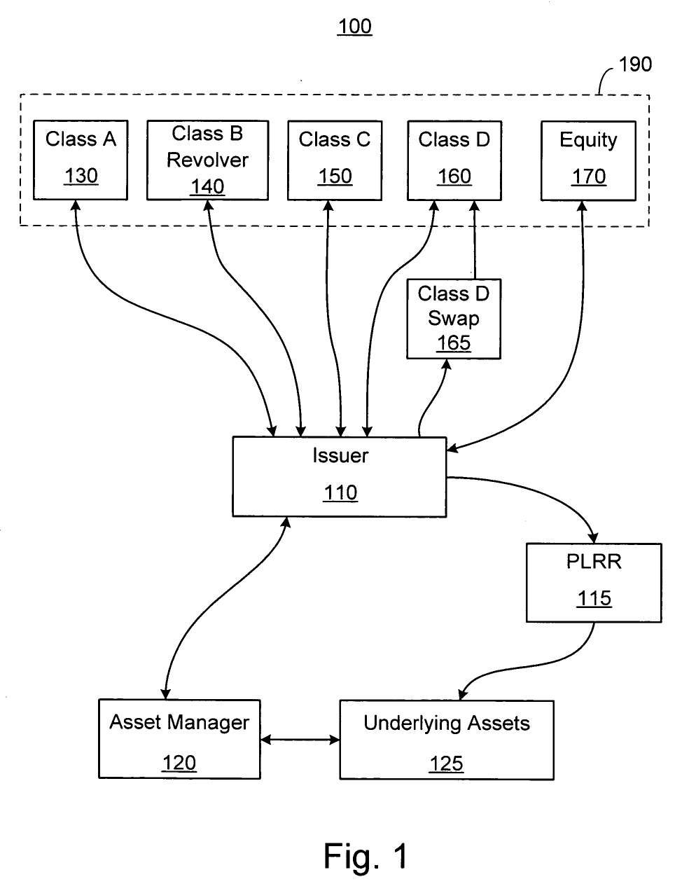

FIG. 1 is a diagram illustrating the transactions and structural features of one embodiment of the present invention. In FIG. 1, the issuer 110 is a SPV organized to purchase the underlying assets (UA) 125, issue the debt and equity tranches 190, and enter into a contract with an asset manager 120 to manage the underlying assets 125. The SPV may also form contracts with other entities that perform services related to the CDO 100.

The underlying assets 125 may include syndicated loans, structured finance securities, and synthetic securities whose reference obligation is a loan. In some embodiments, structured finance securities are less than 10% of the total assets, synthetic securities are less than 30% of the total assets with the balance of the underlying assets in syndicated loans. In a preferred embodiment, structured finance securities may not exceed 5% of the total assets and synthetic securities may not exceed 20% of the total assets.

The debt and equity tranches 190 are issued on the closing date by the issuer 110 in the form of notes for the debt tranches and in the form of preferred shares for the equity tranche. The senior tranche is issued as a class A note 130. The next most senior debt tranche is issued as a class B revolver note 140. Additional debt tranches subordinate to both class A and class B revolver notes may be issued. FIG. 1 shows a preferred embodiment where two additional subordinate debt tranches are issued as a class C note 150 and a class D note 160. The equity tranche may be issued as preferred shares 170.

The proceeds from the sale of the notes and preferred shares are used to purchase the underlying assets 125 and pay for the administrative setup expenses of the CDO 100. Part of the proceeds may be used to fund a Principal Loss Replenishment Reserve (PLRR) account 115. In a preferred embodiment, the issuer 110 makes a one-time payment to the PLRR on the date of closing. The PLRR is used to replenish principal losses in the underlying assets due to defaults or declines in the market value of the underlying assets. The issuer may also open an Interest Reserve Account (IRA) 117 to provide funds for purchasing replenishment assets.

The issuer 110 enters into a contract with the asset manager 120, effective on the closing date, to manage the underlying assets. The asset manager 120 supervises and directs the investment and reinvestment of the portfolio of underlying assets, hereinafter referred to as the collateral, and performs administrative functions on behalf of the issuer 110. The asset manager 120 may also select the underlying assets to be acquired by the issuer, invest and reinvest the collateral, advise the issuer with respect to interest rate risk and cash flow timing, and select and negotiate hedge agreements.

On the closing date, only a portion of the underlying assets comprising the collateral may be purchased. During the ramp-up period following the closing date, the asset manager identifies and purchases the remaining underlying assets until all the underlying assets comprising the collateral are purchased. In some embodiments, the ramp-up period is less than one year, preferably no more than 180 days following the closing date.

The asset manager 120 is constrained in the selection of the underlying assets by a set of portfolio criteria. If a potential asset would violate one or more of the portfolio criteria, the asset manager may not purchase that asset for the collateral without making adjustments that bring the collateral into conformance with the portfolio criteria.

The portfolio criteria include collateral quality tests, eligibility criteria and senior coverage tests. The collateral quality tests quantify characteristics of the portfolio and may include a diversity test, weighted average rating test, weighted average life test, weighted average spread test, Standard & Poor's CDO Monitor Test, or the like. For example, a diversity test may be used to characterize the issuer and industry concentration of the portfolio. In such a test, a high number, or diversity score, may indicate a more diverse portfolio and one of the portfolio criteria may require that the diversity score of the portfolio remain above a minimum diversity score.

The eligibility criteria place constraints on the composition of the collateral based on the characteristics of the underlying asset. Illustrative examples of asset characteristics include the seniority of the asset, whether the asset is secured or unsecured, the frequency of interest payments, whether the interest payments are based on fixed or floating rates, the country of origin of the asset, the rating of the asset, the asset's industry classification group, or maturity date of the asset. For example, one eligibility criterion may be a requirement that at least 95% of the underlying assets pay interest at least quarterly. Another criterion may require that no more than 5% of the collateral be composed of fixed rate underlying assets. Another criterion may require that no more than 5% of the collateral be senior unsecured loans.

The senior coverage tests may include the senior overcollateralization ratio (SOR) test and the senior interest coverage ratio (SICR) test. The senior overcollateralization ratio is determined by dividing the net collateral principal balance by the sum of the outstanding principal amount of the Class A and Class B notes. If the SOR falls below a minimum value required by the SOR test, payments to redeem the principal of the Class A notes are made until the SOR meets the minimum value required by the SOR test. In a preferred embodiment, the minimum value for the SOR is 106.4%, which is lower than a traditional CDO class AB overcollateralization ratio of about 107.1%.

The senior interest coverage ratio is determined by dividing the net collateral interest proceeds by the sum of the scheduled interest on the Class A, B, and C notes, the Class B commitment fee, and defaulted interest, if any, of the Class A and Class C notes. If the SICR fall below a minimum value required by the SICR test, payments to redeem the principal of the Class A notes are made until the SICR meets the minimum value required by the SICR test. In a preferred embodiment, the minimum value for the SICR is 120%.

In a traditional CDO, the SOR declines on a leveraged basis with each dollar of default on the underlying assets. In contrast, the SOR in embodiments of the present invention remains the same or improves as the defaulted assets are replenished. The likelihood of an improved SOR increases due to the availability of assets at a discount where the wider spread is correlated to defaults. The preservation of the senior coverage tests better aligns investment decisions driven by credit compared to CDOs structured to avoid breaching the senior coverage tests.

The selection of the individual portfolio criterion are made by the issuer to maximize the rating of the issued notes by external rating agencies such as, for example, Moody's or Standard and Poor's. Both the structure of the CDO and quality of the collateral are important factors in rating the issued notes. In traditional CDOs, the most subordinate note class is usually rated below investment grade, which greatly increases the difficulty in selling these notes. In contrast, in a preferred embodiment of the present invention, the structure of the CDO and the quality of the collateral may result in all note classes being rated investment grade, thereby increasing the marketability of all note classes.

The asset manager may make adjustments to the collateral during a reinvestment period following the closing date of the CDO. Termination of the reinvestment period may occur on a pre-determined date, when all the notes are redeemed, when market conditions make reinvestment impractical or not beneficial to the holders of the preferred shares, or when a default occurs. In a preferred embodiment, the reinvestment period terminates at the earliest of the termination conditions mentioned above. In a preferred embodiment, the reinvestment period may last for five years.

During the reinvestment period, the asset manager maintains the principal of the collateral by purchasing additional assets to offset any decrease in the value of the collateral caused by defaults of the individual underlying assets or by realized decreases in the market value of the underlying assets. The asset manager calculates the net loss of principal of the collateral for each due period on the determination date, which is the last day of the due period. In some embodiments, interest payments are made quarterly on the payment date. In a preferred embodiment, the payment date follows the determination date by five business days. The net loss of principal is calculated from the defaults in the underlying assets and the aggregated net realized gain/loss of the underlying assets during that due period. Unlike a traditional CDO where only the defaults of the underlying assets contribute to the net loss of principal, the realized gains and losses of the underlying assets also contribute to the determination of the net loss of principal.

If a net loss of principal occurs in a due period, the asset manager purchases additional assets to replenish the net loss of principal. The additional assets are selected such that the portfolio criteria are satisfied.

Unlike other CDOs with replenishment features where additional assets are purchased at a credit event when an underlying asset defaults, embodiments of the present invention replenish the underlying assets at or near the payment date of the preceding due period. By calculating the net loss of principal once per due period, the realized gains or losses of the collateral may easily be incorporated into the net loss of principal calculation. Furthermore, the liquidity requirements are decreased by replenishing the collateral at or near the payment date instead of replenishing the collateral at a credit event.

The decreased liquidity requirements increase the number of qualified entities that can provide the revolver commitment for collateral replenishment. In a traditional CDO, the revolver commitment for collateral replenishment at a credit event usually requires an entity with the highest A-1+ rating. As there are very few entities with such a high rating, the revolver is usually kept by the issuer because it is very difficult to sell the revolver. In contrast, embodiments of the present invention have decreased liquidity requirements for the revolver commitment for collateral replenishment at the payment date and can more easily be sold by the issuer to qualified entities.

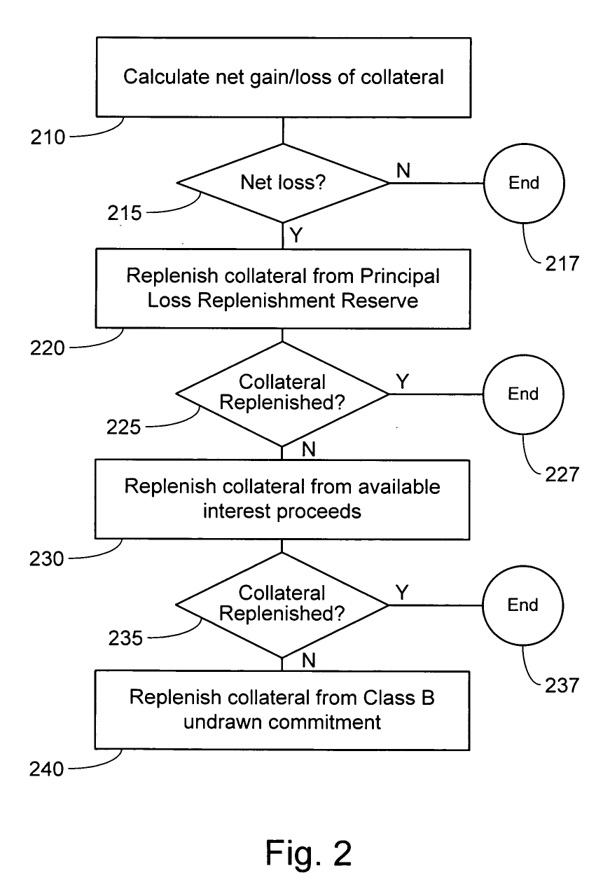

The additional assets may be purchased using funds from three sources. FIG. 2 is a flow diagram illustrating a method for maintaining the principal of the underlying assets. In FIG. 2, the net gain or loss of the collateral is calculated in 210 on the determination date for the determination period. In step 215, if the change is a net gain, replenishment purchases are not required as shown in step 217. If the change is a net loss, replenishment assets are purchased using funds from the PLRR account until that account is reduced to zero in step 220. In step 225, if PLRR account is sufficient to replenish the collateral, additional purchases are not required as shown in step 227. If the PLRR account is insufficient to fully replenish the collateral, additional assets are purchased using funds from excess interest proceeds, including any amounts in the IRA, in step 230. In step 235, if the excess interest proceeds are sufficient to replenish the collateral, additional purchases are not required as shown in step 237. If the excess interest proceeds are insufficient to fully replenish the collateral, additional assets are purchased using funds from the undrawn Class B commitment.

The IRA is funded from excess interest proceeds that would otherwise be available to the preferred shares. In a preferred embodiment, a pre-determined amount is paid into the IRA from the second payment date through the end of the reinvestment period up to an IRA maximum amount. Payment into the IRA is made after the Class D interest payment on the interest waterfall and before distribution to the preferred shares.

The Class B revolver notes are sold as unfunded notes by the issuer on or about the closing date. The Class B note holder does not pay the issuer for the notes at the time of purchase of the notes. Instead, the Class B note holder is committed to providing funds up to the par value of the note to the issuer when the PLRR and interest proceeds are insufficient to fully replenish the collateral. The issuer pays each Class B note holder a commitment fee on each payment date after the Class A notes but before the Class C notes in the interest and principal waterfalls. Any funds drawn on the Class B revolver are repaid after the Class C notes in the interest waterfall and below the Class A notes in the principal waterfall.

In some embodiments, additional credit support may be provided to the most subordinated note class by a coupon swap. Referring to FIG. 1, the most subordinated note class is the Class D note where the issuer enters into a Class D coupon swap agreement with a Class D coupon swap counterparty 165 effective on or about the closing date. The coupon swap benefits the Class D notes by a coupon guarantee for a predetermined number of years of the CDO. In a preferred embodiment, the Class D coupon swap guarantees interest payments to the Class D notes for the first five years although other guarantee periods may be selected and are intended to be within the scope of the present invention. A portion of the offering proceeds is applied to an up-front payment to the counterparty. In return, the counterparty pays to the issuer an amount equal to the scheduled payment of interest on the Class D notes on or before each payment date. The amount paid by the counterparty is applied solely to the payment of interest on the Class D notes. Any payments made to the Class D note holders by the counterparty may be repaid in the interest and principal waterfall payments below the Class D notes.

Further protection may be provided to the Class D notes by accelerating principal payments on the Class D notes to mitigate tail-end risk. In one illustrative example, the interest waterfall is modified after the reinvestment period such that about 25% of the excess interest proceeds available before the payment of the subordinated management fees are used to pay principal on the Class D notes.

In some embodiments, an Excess “CCC” Reserve Account may be established by the issuer to compensate for the below par market value of the non-investment grade underlying assets in the collateral. The amount in the reserve account is determined by the difference between the purchase price and the market value of the portion of the underlying assets rated “Caa1”/“CCC+” or lower by Moody's or S&P that exceeds a predetermined value. As an illustrative example, if the collateral has $1M of underlying assets rated “Caa1”/“CCC+” or lower over a predetermined value and the lowest market values of these assets is 75%, the reserve will equal $250,000. Funds are paid into the “CCC” Reserve Account from interest proceeds according to the interest waterfall after the payment of the Class D interest and before distribution to the preferred shares.

Collections received on the collateral during each due period are segregated into interest proceeds and principal proceeds. The interest proceeds may include all interest and dividends received on the underlying and replenished assets. Principal proceeds may include all payments of principal on the underlying and replenished assets. The interest and principal proceeds are paid out according to a priority sequence usually referred to as a waterfall. The interest and principal proceeds may follow different priority sequences usually referred to as an interest waterfall and principal waterfall, respectively. Distribution of the proceeds continues until all the proceeds are paid out. Any proceeds remaining after the last party on the waterfall is paid, may be distributed to the preferred shares. If, however, the proceeds are insufficient to pay all the parties in the waterfall, the proceeds are paid sequentially to the parties in the order of the waterfall until all the proceeds are paid out. Therefore, parties that are low on the waterfall have a greater probability of not receiving proceeds relative to parties higher up in the waterfall.

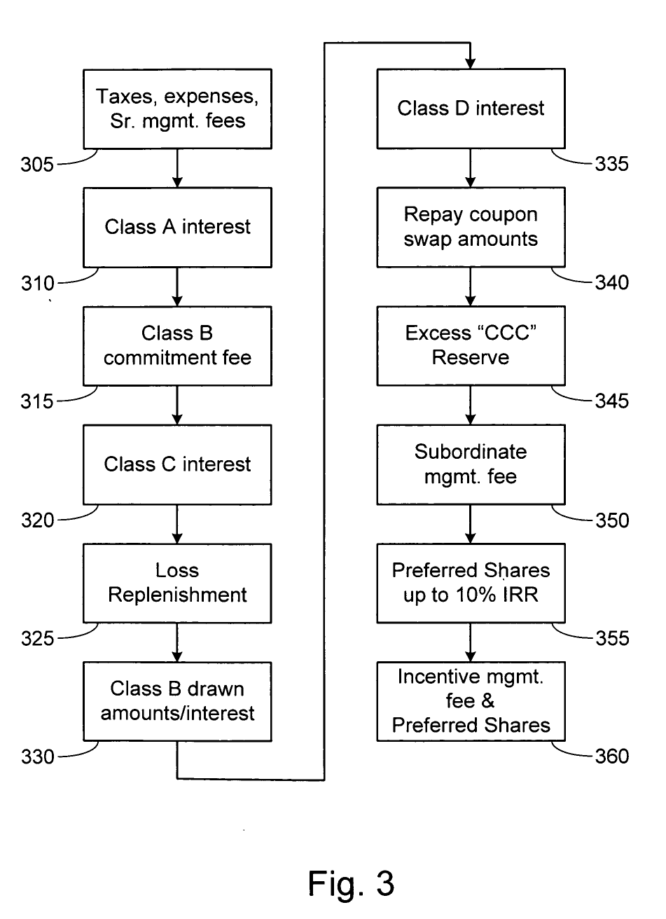

FIG. 3 is a flow diagram illustrating the interest waterfall in one embodiment of the present invention. In FIG. 3, the interest proceeds are first applied to pay all taxes, expenses, and senior management fees of the CDO in 305. Next in 310, all the Class A interest is paid, followed by the Class B commitment fee in 315, and the Class C interest in 320. If a net loss of collateral occurred that was not replenished by the PLRR, interest proceeds are applied to cover the net loss in 325. The Class B accrued and unpaid interest followed by the principal of the Class B notes are paid in 330. The Class D interest not paid by the Class D coupon swap is paid at 335 followed by any reimbursements due to the Class D coupon swap counterparty in 340. Up to 50% of the remaining interest proceeds may be applied to the excess “CCC” reserve in 345, followed by payment of the subordinated management fee in 350. Payments to the Interest Reserve Account is made in 355, followed by dividend payments to the preferred shares such that the preferred shares have up to a 10% internal rate of return in 360. Any proceeds remaining are distributed to the preferred shareholders in 365. In some embodiments, a portion of the remaining proceeds are paid out as an incentive management fee.

If senior coverage cure amounts are required to maintain the senior coverage tests, interest proceeds are applied to the senior coverage cure after the Class C interest 320 but before the loss replenishment 325 is paid in the interest waterfall.

In FIG. 3, repayment of any amounts drawn on the Class B revolver 330 are paid before at least one subordinated note class, such as the Class D interest 335. Repayment of drawn revolver amounts higher in waterfall makes available a larger portion of the interest proceeds for revolver repayment thereby increasing the likelihood of revolver repayment and increasing the marketability of the Class B revolver.

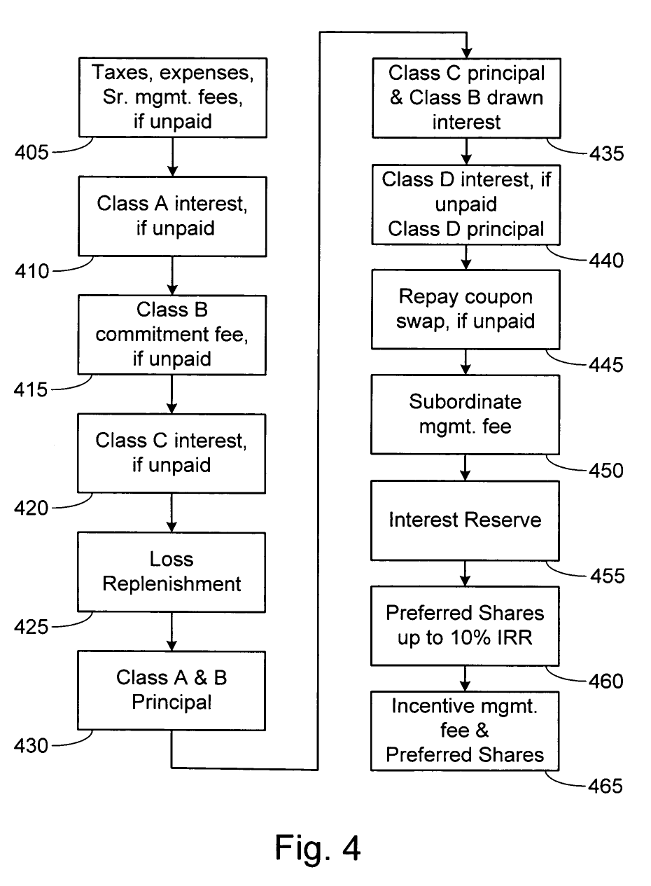

FIG. 4 is a flow diagram illustrating the principal waterfall in one embodiment of the present invention. In FIG. 4 the principal proceeds are paid to cover the taxes, expenses, and fees 405, followed by the Class A interest 410, the Class B commitment fee 415, the Class C interest 420 and the loss replenishment 425 that were not paid by the interest waterfall. After the reinvestment period, the remaining principal proceeds are applied to the Class A principal followed by the Class B principal in 430. After the Class B principal has been paid in full, the Class C principal is paid in 435. After the Class C principal is paid in full, the principal proceeds are applied to pay any Class B accrued and unpaid interest that was not paid in the interest waterfall. In 440, the principal proceeds are applied to pay any Class D interest that was not paid by the interest waterfall followed by payments to the Class D principal until the Class D principal is paid in full. In 445, any Class D coupon swap payments remaining after the interest waterfall are paid by the remaining principal proceeds. Similarly, any subordinated management fee still outstanding after the interest waterfall payments are paid with the principal proceeds in 450, followed by payments to the preferred shareholders such that the preferred shares have up to a 10% internal rate of return in 455. Any principal proceeds remaining are distributed to the preferred shareholder in 460. In some embodiments, a portion of the remaining principal proceeds are paid out as an incentive management fee.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed:

1. A financial product comprising:
a collateral comprising at least one asset, the collateral characterized by a principal value and a net principal loss for a due period terminated by a determination date when the net principal loss is calculated for the due period;
a senior debt tranche;
a revolver debt tranche subordinate to the senior debt tranche;
at least one subordinate debt tranche subordinate to the revolver debt tranche; and
an equity tranche subordinate to the at least one subordinate debt tranche and issued as a preferred share,
wherein the revolver debt tranche is commited to providing funds equal to the net principal loss at a payment date that is a predetermined number of days following the determination date.

2. The financial product of claim 1 wherein the payment date is five business days after the determination date.

3. The financial product of claim 1 wherein the net principal loss is determined from a realized gain of the at least one asset during the due period, a realized loss of the at least one asset during the due period, and a default in the at least one asset during the due period.

4. The financial product of claim 1 wherein the senior debt tranche is issued as a Class A note and the revolver debt tranche is issued as a Class B revolver note.

5. The financial product of claim 4 wherein the at least one subordinate debt tranche further comprises:
a first subordinated debt tranche issued as a Class C note, the Class C note subordinate to the Class A note and the Class B revolver note;
a second subordinated debt tranche issued as a Class D note, the Class D note subordinate to the Class A note, the Class B revolver note, and the Class C note; and
a coupon swap guaranteeing a coupon on the Class D note for a predetermined period of time.

6. The financial product of claim 5 wherein the predetermined period of time is five years.

7. The financial product of claim 5 wherein the Class D note is characterized by an investment rating not lower than investment grade.

8. The financial product of claim 1 further comprising a principal loss replenishment reserve, the reserve providing funds to purchase a replenishment asset to maintain the principal value of the collateral.

9. The financial product of claim 8 wherein the reserve provides funds to purchase the replenishment asset before funds are provided by the revolver debt tranche.

10. The financial product of claim 1 wherein the equity tranche is no more than 7% of the collateral.

11. The financial product of claim 1 wherein funds provided by the revolver debt tranche are repaid from an interest proceeds generated by the collateral before the interest proceeds are paid to the at least one subordinated debt tranche.

12. The financial product of claim 1 wherein an interest proceeds generated by the collateral are paid to the at least one subordinated debt tranche before funds provided by the revolver debt tranche are repaid from the interest proceeds.

13. A method of securitizing a collateral of assets, the collateral characterized by a principal value, the method comprising:
calculating a net principal loss of the collateral during a due period on a determination date, the determination date terminating the due period; and
purchasing at least one replenishment asset on a payment date to maintain the principal value of the collateral, the payment date following the determination date by a predetermined period.

14. The method of claim 13 wherein the predetermined period is in the range of one business day to ten business days.

15. The method of claim 14 wherein the predetermined period is five business days.

16. The method of claim 13 further comprising issuing a subordinated revolver note to a revolver noteholder, the revolver noteholder committed to providing funds to purchase the at least one replenishment asset.

17. The method of claim 16 wherein the revolver noteholder provides funds to purchase the at least one replenishment asset after funds are exhausted from a principal loss replenishment reserve.

18. The method of claim 16 wherein the revolver noteholder provides funds to purchase the at least one replenishment asset after funds are exhausted from an interest proceeds collected from the collateral during the due period.

19. The method of claim 18 wherein funds provided by the revolver noteholder are repaid with the interest proceeds on the payment date before a dividend is paid to a preferred shareholder.

20. The method of claim 13 wherein calculating the net principal loss further includes:
determining an aggregate realized gain in the collateral;
determining an aggregate realized loss in the collateral; and
determining an aggregate loss in the collateral caused by a default.

21. The method of claim 13 wherein the collateral is comprised of syndicated loans, structured finance securities, and synthetic securities whose reference obligation is a loan.
